(19) United States
(12) Patent Application Publication
(10) Pub. No.: US 2006/0287886 A1
(43) Pub. Date: Dec. 21, 2006

(54) Method and apparatus for generating medicine information

(75) Inventor: Emiko Kitazawa, Nagano (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/359,705

(22) Filed: Feb. 22, 2006

(30) Foreign Application Priority Data
Jun. 17, 2005 (JP) 2005-177996

(51) Int. Cl. G06Q 10/00

(52) U.S. Cl. 705/2

(57) ABSTRACT

A medicine information outputting apparatus includes a medicine comment table for storing comments relating to combinations of medicine names. A prescription information receiving program receives prescription information from a user, and a comment information extracting program extracts from the medicine comment table, a comment corresponding to a combination of the medicine names included in the prescription information. A list outputting program outputs the medicine information including the medicine names included in the prescription information and the comment corresponding to the combination of the medicine names in the prescription information.

### FIELD OF THE INVENTION

The present invention relates to a method and apparatus for generating medicine information in a diagnosis support system such as an electronic medical chart system. The present invention, in particular, is aimed at making it easier for a patient to understand medicine information by dynamically changing comments included in the medicine information.

### BACKGROUND OF THE INVENTION

In medical institutions, information describing the usage of a medicine is given to a patient when the medicine is prescribed. A medicine information offering system for generating the names of the medicines prescribed to a patient, photographs of the medicines, functions of the medicines, usage, and other medicine information is known.

Medicine information offering systems also provide notes for the medicines in the medicine information, for example warnings for potential side effects of the medicine. The notes might be stored in a database for each medicine.

In some cases, a medicine is prescribed for purposes which are different from a commonly known usage. For example, a medicine for a stomach ailment may be prescribed to a patient with dermatitis to alleviate stomach problems caused by other medicines for dermatitis. In this case, a comment such as “This medicine is for upset stomach,” for example, may be written in the notes of the medicine. A patient reading this note may wonder why this medicine has been prescribed, when the patient does not have a stomach problem.

### SUMMARY OF THE INVENTION

The present invention is directed to a medicine information outputting apparatus including a medicine comment table for storing comments relating to combinations of medicine names. A prescription information receiving program receives prescription information from a user, and a comment information extracting program extracts from the medicine comment table, a comment corresponding to a combination of the medicine names included in the prescription information. A list outputting program outputs the medicine information including the medicine names included in the prescription information and the comment corresponding to the combination of the medicine names in the prescription information.

### BRIEF DESCRIPTION OF THE DRAWINGS

FIG. 1 is a diagram of a diagnosis support system in accordance with one embodiment of the present invention;

FIG. 2 is a flowchart describing the operation of the diagnosis support system shown in FIG. 1;

FIG. 3 is a sample screen used in conducting a patient search;

FIG. 4 is a example of a screen for editing diagnosis information of a patient;

FIG. 5 is a flowchart describing the process for editing the chart shown in FIG. 4;

FIG. 6 is a flowchart for describing a process for outputting medicine information;

FIG. 7 is a table representing the medicine comment table shown in FIG. 1;

FIG. 8 is a table illustrating the work area of a memory shown in FIG. 1;

FIG. 9 is a sample medicine information generated by the diagnosis support system shown in FIG. 1;

FIG. 10 is a patient diagnosis editing screen in accordance with another embodiment of the present invention;

FIG. 11 is a flowchart describing a process for generating the medicine information in accordance with another embodiment of the present invention; and

FIG. 12 is a diagnosis support system in accordance with another embodiment of the present invention.

### DETAILED DESCRIPTION OF THE INVENTION

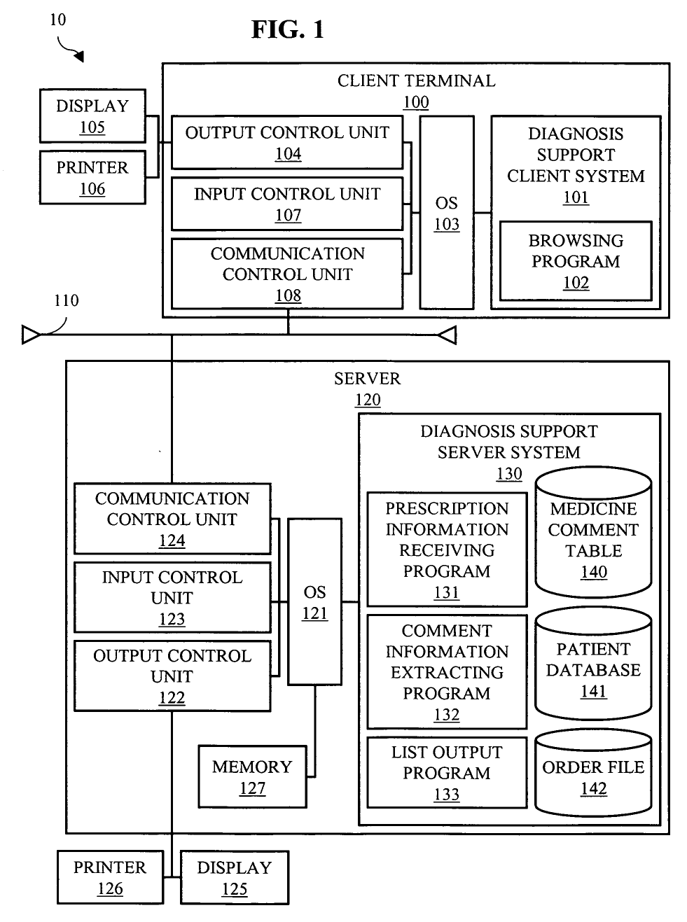

FIG. 1 shows a diagnosis support system 10 in accordance with one embodiment of the present invention. The diagnosis supporting system 10 is adapted to be provided in a medical institution such as a hospital or a clinic. In a medical institution, a server 120 and a client terminal 100 are connected via a network 110 such as a LAN, for example. In FIG. 1, only one client terminal 100 is illustrated. However, the diagnosis support system 10 may include numerous client terminals 100 that are connected through the network 110 to the server 120. The system configuration of each client terminal 100 is substantially identical.

The server 120, including a diagnosis support server system 130, is controlled by an operating system (OS) 121. The diagnosis support server system 130 includes a prescription information receiving program 131 for accepting prescription information from the user, a comment information extracting program 132 for extracting comments from a medicine comment table 140, and a list output program 133 for editing and outputting medicine information.

The diagnosis support server 130 also includes the medicine comment table 140 for storing comments regarding medicine, and a patient database 141 for storing patient information such as patient name, sex, age and medical records, for example. An order file 142 is provided for storing order information from the user to other departments in the medical institution such as the pharmacy department or the X-ray department, for example. The order information stored in the order file 142 may be sent to or retrieved from the other departments. These databases are referred to or updated, as required, by the prescription information receiving program 131, the comment information extracting program 132, and the list output program 133.

The server 120 also includes an output control unit 122 for controlling a display device 125, a printing device such as a printer 126 for printing various information to be given to the user or the patient, an input control unit 123 for controlling input information from the user, and a communication control unit 124 for controlling communication with the client terminal 100.

The client terminal 100 includes an operating system (OS) 103 for operating a diagnosis support client system 101. The client terminal 100 may be a personal computer, for example. The diagnosis support client system 101 is generally a browsing program 102 for inputting and outputting information to and from the diagnosis support server system 130.

The client terminal 100 further includes an output control unit 104 for controlling a display 105 and a printing device such as a printer 106 for printing various information for the user, an input control unit 107 for controlling information input from the user, and a communication control unit 108 for controlling communication with the server 120.

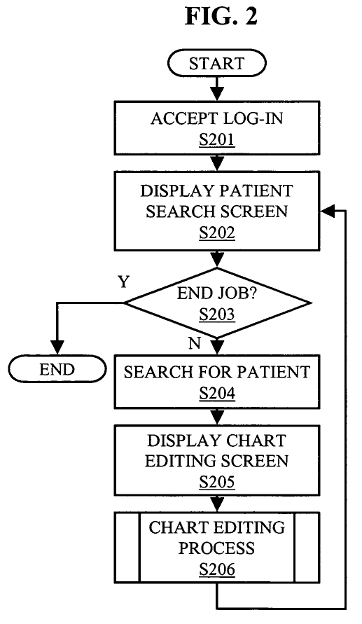

The operation of the diagnosis supporting system 10 of the present invention is now described with reference to FIG. 2. First, a user logs into the diagnosis support server system 130 from the diagnosis support client system 101 of the client terminal 100 (S201). The diagnosis supporting server system 130 authenticates the user with known user authentication procedures and then displays a search screen on the display unit 105 of the client terminal 100 (S202).

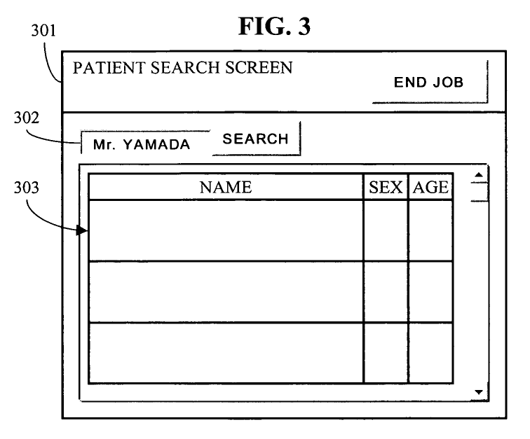

As shown in FIG. 3, one embodiment of the patient search screen 301 includes a name of the screen (PATIENT SEARCH SCREEN) and a job end (END JOB) button, a search key input field 302 for displaying the name to be searched, and a search button (SEARCH). A list display area 303 for displaying a list of search results is also provided. The list display area 303 may include information such as the name, sex and address of the patient, for example.

To end a search on the search screen 301, the user selects the END JOB button by clicking on the button with a cursor or by depressing or touching the button with a finger. The diagnosis support server system 130 ends the search when it accepts a signal generated from the END JOB button (S203).

A patient search process is executed when the SEARCH button is selected with the name of the patient to be searched input in the search key input field 302 of the search screen 301 (S204). The diagnosis support server system 130 searches the patient data stored in a patient database 141, extracts the information of the patient, and then displays this information on the list display area 303 of the search screen 301.

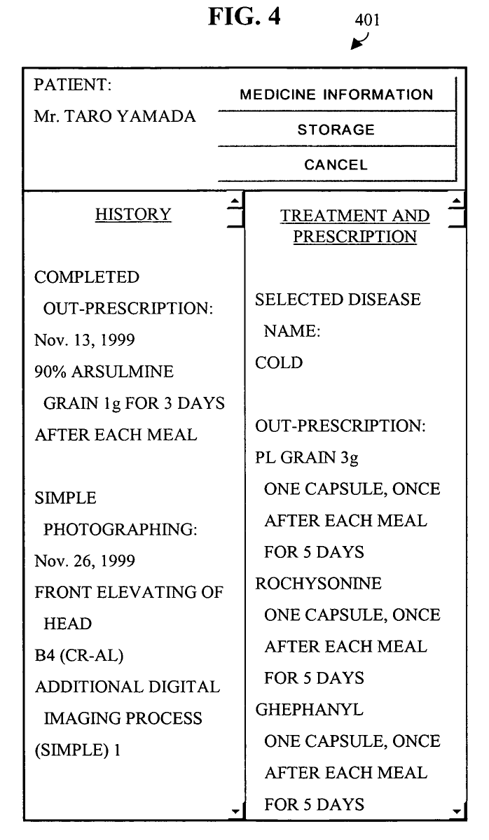

When the user selects a patient from the list display area 303 of the patient search screen 301, the diagnosis support server system 130 displays a chart editing screen 401 (shown in FIG. 4) for displaying the chart information of the patient (S205). The chart editing screen 401 is provided with the name of the patient 402 (Mr. Taro Yamada), a medicine information button (MEDICINE INFORMATION) for outputting information relating to the medicine for a patient, a storage button (STORAGE) storing the diagnosis information inputted, and a cancellation button (CANCEL) for ending input of the diagnosis information without storage thereof. Moreover, the editing screen 401 has a history column (HISTORY) for displaying information such treatments and prescriptions in the past, for example, and a current treatment and prescription column (TREATMENT AND PRESCRIPTION) for editing or inputting the current treatment and/or prescription information for the patient.

The editing screen 401 shown in FIG. 4 is displayed on the display unit 105 for the patient, Mr. Taro Yamada, for example. When the editing or inputting of diagnostic information of the patient is completed and the user selects either the STORAGE button or the CANCEL button of the chart editing screen 401, the process returns to the step S202, and the search screen 301 is again displayed. The edited contents are stored when the STORAGE button is selected, and not stored, when the CANCEL button is selected.

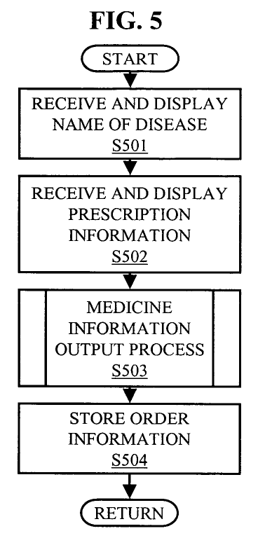

The chart editing process of step S206 is shown in FIG. 5. When a disease name is input by the user via the input control unit 107 (shown in FIG. 1), the prescription information receiving program 131 displays it in the TREATMENT AND PRESCRIPTION column of the chart editing screen 401 (S501). FIG. 4 illustrates that a disease name “COLD” has been received.

Subsequently, the prescription information (i.e., medicine names) receiving program 131 receives a prescription input from the user, it is also displayed in the TREATMENT AND PRESCRIPTION column (S502). The chart editing screen 401 shown in FIG. 4 illustrates that the medicines such as “PL gain of 3 g” and the usages of this medicine has been received from the user.

Next, when the user depresses the MEDICINE INFORMATION button provided in the chart editing screen 401, the diagnosis support server system 130 executes the output process of the medicine information to be provided to the patient (S503).

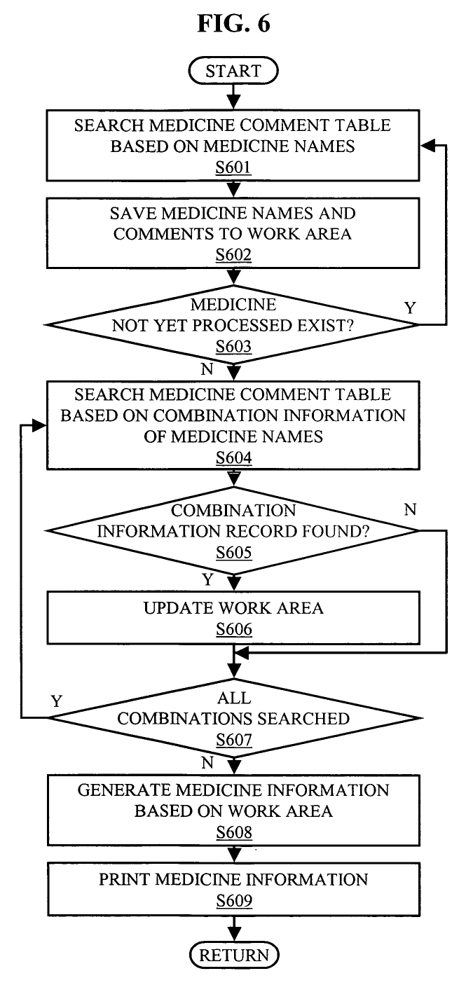

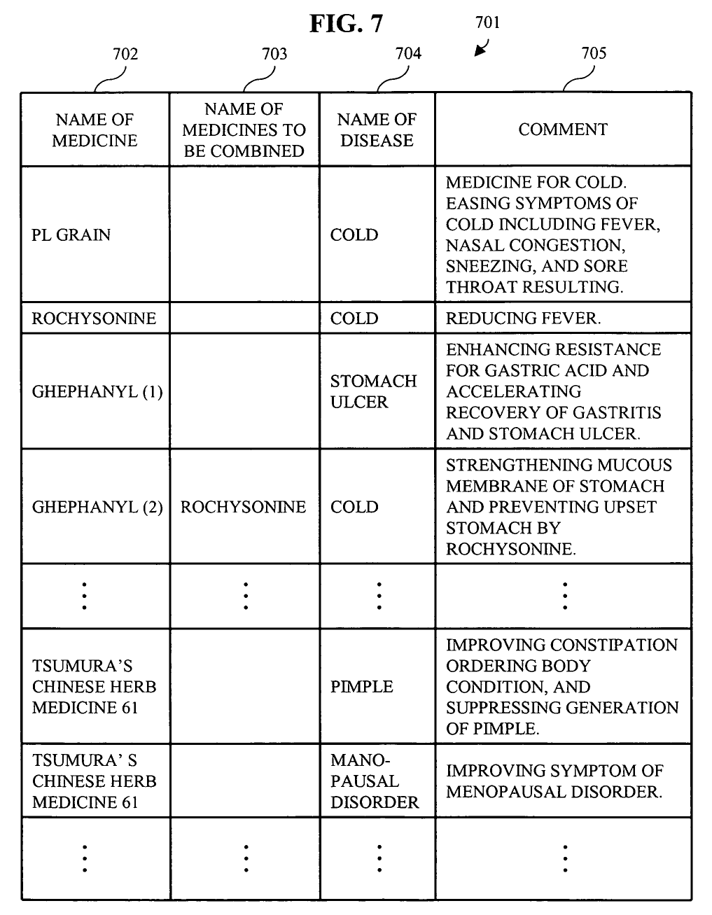

One embodiment of the medicine information output process is shown in FIG. 6. First, the comment information extracting program 132 searches the medicine comment table 140 (shown in FIG. 1) using, as the search key, the names of the medicines input in the TREATMENT AND PRESCRIPTION column of the chart editing screen 401 by the user (S601). For example, in the case where “PL GRAIN” is selected by the user as shown In FIG. 4, the comment stored in the record of the “PL GRAIN” is used. The medicine comment table 140 is illustrated in more detail as a medicine comment table 701 in FIG. 7. The medicine comment table 701 includes columns for the name of medicine 702, the name of medicines to be combined 703, the name of the disease 704, and comments 705.

In the example of the medicine comment table 701 there are two records for ghephanyl. Ghephanyl is generally used for stomach ulcer. Therefore, the comment “enhancing resistance for gastric acid and accelerating recovery of gastritis and stomach ulcer” is stated in the COMMENT column 705 for GHEPHANYL (1), since no other medicine is to be combined with GHEPHANYL (1) in the NAME OF MEDICINES TO BE COMBINED column 703.

However, in some cases, ghephanyl is also prescribed to suppress the side effects of other medicines such as rochysonine, for example, for cold. In that event, if the same comment with respect to GHEPHANYL (1) is issued, the patient might be confused as to why a medicine for a stomach ailment has been prescribed for cold symptoms. In view of eliminating such problem, it is desirable to output the comment which clearly defines inherent purpose of the medicine such as “strengthening mucous membrane of stomach and alleviating upset stomach caused by rochysonine,” as shown in the COMMENT column 705 for GHEPHANYL (2), when rochysonine is combined with ghephanyl.

As another example, two records also exist for the Tsumura's Chinese herb medicine 61. These two records are different in that they are directed to different medical conditions. In the case of the Tsumura's Chinese herb medicine, a comment suitable for the disease name of the patient is selected and outputted. Tsumura's Chinese herb medicine 61 is prescribed for symptoms of various diseases, and therefore, it is difficult to define a general comment. Accordingly, the comments suitable for respective disease names are defined.

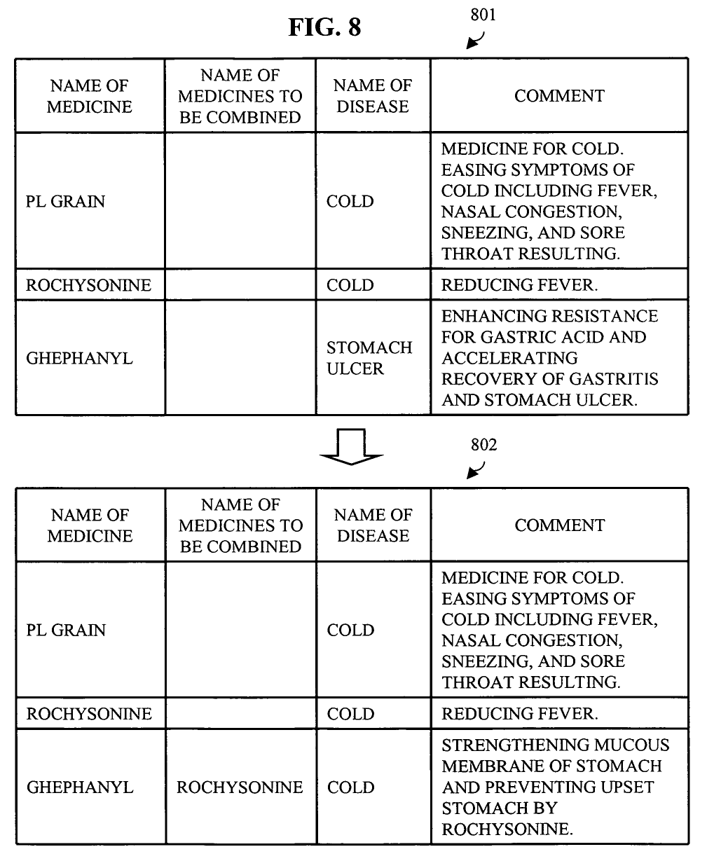

In determining the appropriate comment to select from the medicine comment table 140, a search is conducted using, as the search key, the medicine names of PL grain, rochysonine, and ghephanyl which have been inputted to the TREATMENT AND PRESCRIPTION column of the chart editing screen 401 (S601). The comment obtained as a result of the search is saved, together with each medicine name, into a work area within the memory device 126 (S602). The information to be saved into the work area is illustrated, as an example, in a work area 801 of FIG. 8. In this stage, a general comment for each medicine is stored.

When these processes are completed for all medicines (S603) the medicine comment table 701 is searched using combination of medicines instead of individual medicines (S604). More specifically, search is conducted using all possible combinations such as PL grain and rochysonine, PL grain and ghephanyl, rochysonine and PL grain, rochysonine and ghephanyl, ghephanyl and PL grain, and ghephanyl and rochysonine.

First, the medicine comment table 701 is searched using, as the combination key, PL grain and rochysonine. It is decided whether the relevant record, namely the record where the PL grain is defined as the medicine name and the rochysonine is defined as the medicine to be combined, exists (S605). Since the searched record does not exist in this case, the search is repeated for all combinations (S607). When the search is conducted for the combination of ghephanyl and rochysonine, the record in which ghephanyl is defined as the medicine name and rochysonine is defined as the medicine to be combined exists, is found.

Thereafter, the corresponding record in the work area in the memory 127 is updated (S606). More specifically, the comment for the record indicating ghephanyl in the work area 801 is updated to the comment which is output when the ghephanyl and rochysonine are prescribed simultaneously, as shown in work area 802.

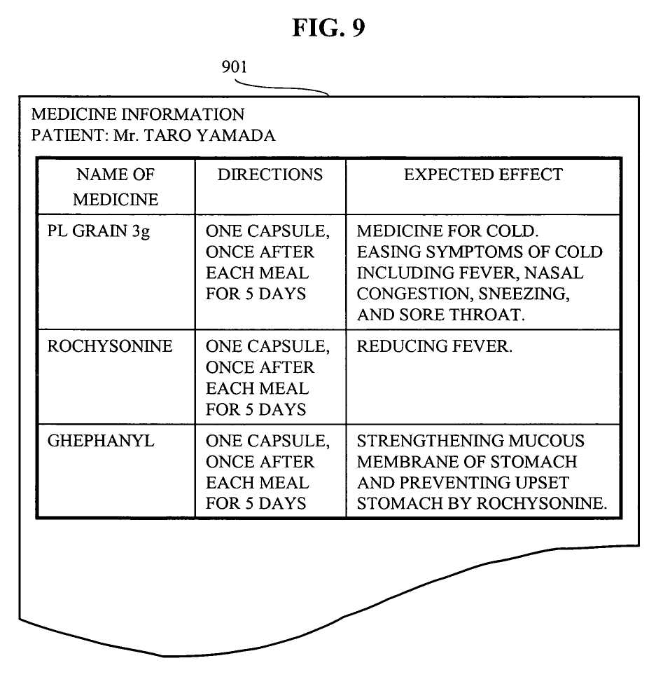

When the searches for all combinations explained above are completed (S607), the list output program 133 (shown in FIG. 1) generates medicine information in the memory 127 using the information of the work area 802 (S608). The medicine information is printed by the printer 126 or the printer 106 (S609), and to the patient. An example of the format and the content medicine information is illustrated in FIG. 9. The medicine information includes the name of the medicine input to the TREATMENT AND PRESCRIPTION column of the chart editing screen 401, directions for taking the medicine, and the expected effect of the medicine, as stated in the comment column for the same medicine in the work area 802.

Thereafter, when the STORAGE button is selected on the chart editing screen 401, the disease name and the prescription information (i.e., medicine names) input to the TREATMENT AND PRESCRIPTION column 404 are stored to the order file 142 allowing access by other users or departments (S504), and to the patient database 141. When the CANCEL button is selected, the disease name and the prescription order are not stored.

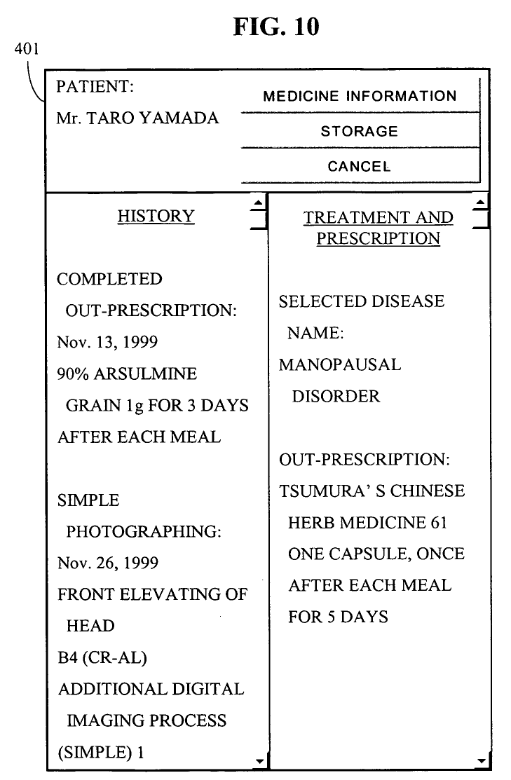

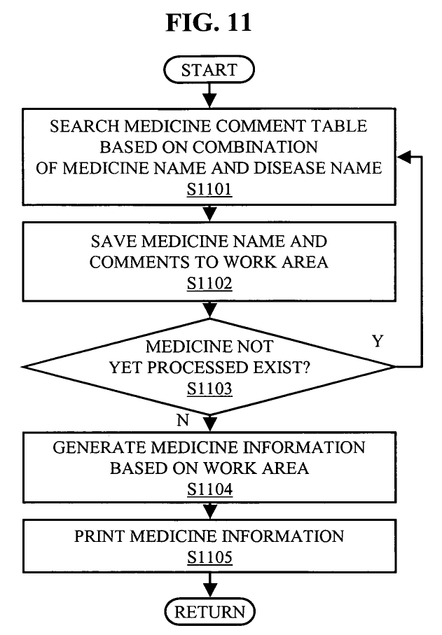

As explained in the above-described embodiment, it is possible to output comments based on the combinations of medicines. In accordance with another embodiment of the present invention, comments are extracted on the basis of the combinations of medicines and disease names. As an example, menopausal disorder is input as the disease name and Tsumura's Chinese herb medicine 61 is input as the prescription order in the TREATMENT AND PRESCRIPTION column of the chart editing screen 401 as illustrated in FIG. 10. When the medicine information output process is conducted under this condition, the processes illustrated in FIG. 11 are executed.

First, the medicine comment table 701 is searched by the comment information extracting program 132 on the basis of the information combining the medicine name and the disease name, i.e., using a combination of the Tsumura's Chinese herb medicine 61 and menopausal disorder (S1101). As a result, the comment “Improving symptoms of menopausal disorder” which is suitable for the disease name is acquired from the COMMENT column 705. The comment information extracting program 132 saves this comment to a work area within the memory device 127 together with the medicine name (S1102). All medicine names input in the TREATMENT AND PRESCRIPTION column of the chart editing screen 401 of FIG. 10 is searched in combination with input disease name, i.e., menopausal disorder (S1103). In FIG. 10, only one medicine is input in the TREATMENT AND PRESCRIPTION column by the user.

The medicine information is then stored in the memory 127 from the work area (S1104). Thereafter, the medicine information is printed by the printer 126 or the printer 106 (S1105). Thus, the comments can also be output on the basis of the combination of medicine and disease name.

As explained above, the present invention provides medicine information which includes a comment which can be changed in accordance with the combination of medicines prescribed to the patient. Moreover, the present invention provides a medicine information which includes a comment which can be changed in accordance with the combination of the medicine prescribed to the patient and the disease name inflicting the patient.

In the above-described embodiments of the present invention, medicine information is generated in a diagnosis support system such as an electronic chart system or an ordering system. In accordance with another embodiment of the present invention, a diagnosis support server system receives order information from a user and stores it in the order file 142. The order information is then transferred to a medicine preparation support system, which generates and prints the medicine information.

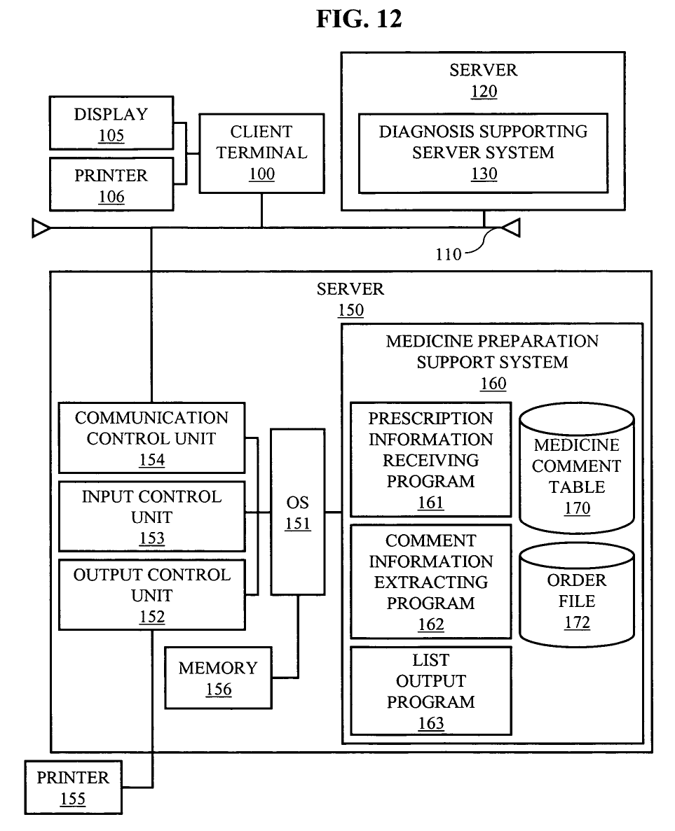

The system configuration of this embodiment is illustrated in FIG. 12 as an example. The elements that are similar to those in FIG. 1 are designated with the like reference numerals. In the medicine preparation support system 160 of a server 150, a prescription information receiving program 161, a comment information extracting program 162, a list output program 163, a medicine comment table 170, and a order file 172 correspond respectively to programs and tables 131, 132, 133, 140, and 142 of the diagnosis supporting server system 130 of the server 120 (shown in FIG. 1).

When the prescription information receiving program 161 of the medicine preparation supporting system 160 receives the order information (i.e., prescription order information) including the disease name and the prescription stored in the order file 142 of the diagnosis supporting server system 130, it stores the prescription order information in the order file 172, and the medicine information outputting process described above with respect to FIG. 6 or FIG. 11 is executed using the prescription order information now stored in the order file 172. Namely, the comment information extracting program 162 searches the medicine comment table 170 using the prescription order information received by the prescription information receiving program 161. The list output program 163 outputs the medicine information.

The server 150 is operated by the OS 151 including medicine preparation support system 160. Moreover, the server 150 comprises the output control unit 152 for controlling the display unit (not illustrated) and a printer 155 for printing the medicine information for the user, the input control unit 153 for controlling information input from the user, and the communication control unit 154 for controlling communication with the client terminal 100. The client terminal 100 may be substantially identical to the client terminal 100 shown in FIG. 1, but it is desirable that the client terminal for the medicine preparation support system 160 be provided in the medicine preparation section of a medical institution. The client terminal 100 is also provided with a printer 106.

In the above described embodiment of the present invention, a client-server system has been explained as an example, but the present invention is not limited to the system configuration explained above. For example, data has been stored in the diagnosis support server system 130 in the above-described embodiments, but the similar operations can be achieved by storing such data in the diagnosis support client system 101 of each client terminal. Moreover, the diagnosis support system 10 may be implemented in a personal computer within a small medical institution. In this case, the similar system can also be realized by providing each program and data stored in the diagnosis supporting server system 130 would be included in the diagnosis support client system 101.

Moreover, each program explained in this embodiment may be distributed in a recording medium such as a CD-ROM or the like, and the processes explained above can be realized by installing the programs into a computer using such recording medium.

In addition, the diagnosis support server system 130 is not required to be within a medical institution. The server system 130 may be operated by an application service provider (ASP). In this case, the processes explained above can be realized by implementing the diagnosis information input support method of the present invention with the server of the ASP provider, and the diagnosis support client system 101 in each medical institution would print the medicine information. Therefore, the server of the ASP executes the processes up to the generation of an image for printing at the diagnosis support client system.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A medicine information outputting apparatus comprising:
a medicine comment table for storing at least one comment relating to at least one combination of at least two medicine names;
prescription information receiving means for receiving prescription information from a user;
comment information extracting means for extracting from said medicine comment table, a comment corresponding to a combination of at least two medicine names included in said prescription information received by said prescription information receiving means; and
list outputting means for outputting the medicine information including said medicine names included in said prescription information and said comment corresponding to said combination of said at least two medicine names.

2. The apparatus as defined in claim 1, wherein said medicine comment table comprises:
a plurality of medicine names;
a comment corresponding to each of said medicine names; and
a comment corresponding to each of at least one combination of any of said plurality of medicine names.

3. The apparatus as defined in claim 2, wherein said comment information extracting means extracts from said medicine comment table, all individual medicine names included in said prescription information received by said prescription information receiving means and comments corresponding to said medicine names, and any combination of said extracted individual medicine names having a corresponding comment.

4. The apparatus as defined in claim 3, wherein said medicine information is output to a printer.

5. The apparatus as defined in claim 1, further comprising means for enabling the user to remotely send said prescription information to said prescription information receiving means.

6. A medicine information outputting method comprising:
receiving prescription information from a user;
extracting from a medicine comment table for storing comments relating to at least one combination of at least two medicine names, a comment corresponding to a combination of at least two medicine names included in said prescription information received; and
outputting medicine information including said medicine names included in said prescription information and said comment corresponding to said combination of said at least two medicine names.

7. A medicine information outputting apparatus comprising:
a medicine comment table for storing comments relating to a combination of a medicine name and a medical condition;
prescription information receiving means for receiving prescription information and medical condition information from a user;
comment information extracting means for extracting from said medicine comment table, a comment corresponding to a combination of a medicine name and a medical condition included in said prescription information received by said prescription information receiving means; and
list outputting means for outputting medicine information including said medicine name, said medical condition and said comments corresponding to said combination of said medicine name and said medical condition included in said prescription information.

8. The apparatus as defined in claim 7, wherein said medicine comment table comprises at least one medicine name having a plurality of corresponding medical conditions, and at least one medical condition having a plurality of corresponding medicine names.

9. The apparatus as defined in claim 7, further comprising means for enabling the user to remotely send said prescription information to said prescription information receiving means.
